(19) United States
(12) Patent Application Publication
(10) Pub. No.: US 2004/0177006 A1
(43) Pub. Date: Sep. 9, 2004

(54) Parts kit production support system and program using associated parts identification data and shelf position identification data

(75) Inventors: Masaki Matsumoto, Sayama-shi (JP); Hirokazu Nakayama, Tokyo (JP)

Correspondence Address: ARENT FOX KINTNER PLOTKIN & KAHN, PLLC, 1050 Connecticut Avenue, N.W., Suite 400, Washington, DC, 20036-5339, US

(73) Assignees: HONDA MOTOR CO., LTD.; NIHON CLIN CO., LTD.

(21) Appl. No.: 10/785,004

(22) Filed: Feb. 25, 2004

(30) Foreign Application Priority Data
Feb. 28, 2003 (JP) 2003-53301

(51) Int. Cl. G06G 1/14; G06F 17/60; G03B 17/24

(52) U.S. Cl. 705/22

(57) ABSTRACT

A production support system including an order database storing order data which indicates a required parts kit, and specification data indicating parts included in the parts kit; a stock database for stocked parts; a section for associating data of a parts slip appended to received parts with the order data and storing associated data into the order database; a section for issuing a reception slip describing parts identification data; a section for associating the parts identification data with shelf position identification data assigned to a shelf for the relevant parts, and storing associated data into the stock database; a section for confirming whether reception of specific parts has been completed by a predetermined period before the specific date; and a section for outputting a collection instruction sheet including data of the parts to be packaged together and the shelf position identification data when completion of the reception is confirmed.

### BACKGROUND OF THE INVENTION

1. Field of the Invention

The present invention relates to a parts kit production support system and to a program for supporting a process for producing parts kits (or parts sets), in which a plurality of related parts are packed together in each parts kit.

Priority is claimed on Japanese Patent Application No. 2003-053301, filed Feb. 28, 2003, the content of which is incorporated herein by reference.

2. Description of the Related Art

In order to perform storage of products and to collect packaging history data in consideration of a product delivery plan, conventional systems for managing the process relating to product packaging may include:

(1) a transfer management section for delivering unfinished products from an unfinished product storage based on a delivery plan and for sending data of the delivery plan and delivery history,

(2) a packaging management section for determining the transportation quantity in each transportation using a transport machine to a product storage by determining the package number and the quantity in package plan based on the data of the delivery plan and history, and for sending, every time the actual packaging quantity in the packaging line reaches the transportation quantity, “coincidence” data (which indicates coincidence of both quantities) and delivery history data, and

(3) a transportation management section for determining a storage place in the product storage based on (i) data of the package number, the quantity in the package plan, etc., based on the delivery history and (ii) storage data provided by a storage management section, and for outputting a slip for designating the storage place to the operator of the transport machine every time the transportation management section receives the coincidence data from the packaging management section (refer to Japanese Unexamined Patent Application, First Publication No. Hei 08-175627).

In the field of handling manufactured products such as cars, each consisting of multiple parts, when a plurality of parts for producing the product are sold for repair use, small parts such as O-rings and packings may be sold in an assembled form (i.e., as a set). In the following explanation, a collection of a plurality of small parts is called a “parts kit”. Generally, such small parts are produced by different manufacturers for each kind of part, and there are also parts kit manufacturers for collecting parts and producing parts kits.

In ordinary production of parts and parts kits, considerable time is required from when the parts manufacturer receives an order, to the processing of the ordered parts; however, time permissible for the parts kit manufacturer to perform packaging and forwarding is generally short. For example, only 2 to 3 days are allotted even when a variety of different parts should be collected and packaged. In addition, parts forwarded from the parts manufacturer often reach the parts kit manufacturer at a late date which is after the designated arrival time; thus, the parts kit manufacturer needs to perform (i) management of parts whose receipt has been delayed, (ii) approach for promoting reception of the parts, (iii) preparation for quickly performing packaging and forwarding after the delay parts are received, and (iv) management of storage shelves for parts which are irregularly received.

Conventionally, such works are performed independently. However, when management data are dispersed, unnecessary parts may be erroneously packaged and parts kits including erroneous parts may be produced, and in addition, considerable man power is required for management of parts reception, stock management, collection of parts, and the like.

In order to efficiently collect parts to be packaged together and package the collected parts, merely managing the storage place and the packaging history, as disclosed in Hei 08-175627, is insufficient. That is, in addition to such management, (i) centralized management of the state of reception and the storage places of parts to be packaged together, and (ii) management of collection and packaging of necessary parts based on the scheduled date for forwarding the relevant parts kits, are also necessary.

### SUMMARY OF THE INVENTION

In consideration of the above circumstances, an object of the present invention is to provide a parts kit production support system and program for supporting a process for producing parts kits, in each of which a plurality of related parts are packed together, and for improving the efficiency of the production process.

Therefore, the present invention provides a parts kit production support system for supporting production of a parts kit in which predetermined parts are packaged together, comprising:

an order database (e.g., an order database 11 in an embodiment explained below) for storing, in advance, order data which indicates data of the parts kit required by an orderer, and specification data which indicates data of parts included in the parts kit;

a stock database (e.g., a stock database 12 in the embodiment) for storing data of stocked parts;

a reception accepting section (e.g., a reception accepting section 13 in the embodiment) for associating parts slip data with the order data and storing the associated data into the order database, wherein the parts slip data, input using a terminal (e.g., reception processing terminals 3-1 to 3-n in the embodiment), is data of a parts slip which is appended to each received unit of parts;

a reception slip issuing section (e.g., a reception slip issuing section 14 in the embodiment) for issuing, according to the data stored in the order database, a reception slip in which parts identification data for identifying the received parts are described;

a stock management section (e.g., a stock management section 15 in the embodiment) for associating the parts identification data, which is described in the reception slip and is input using a terminal (e.g., stock management terminals 4-1 to 4-m in the embodiment), with shelf position identification data which is also input using a terminal (e.g., stock management terminals 4-1 to 4-m in the embodiment) and is individually assigned to a shelf on which the relevant parts are stored, and storing the associated data into the stock database;

a stock state confirming section (e.g., a stock state confirming section 16 in the embodiment) for confirming a date of shipment of the parts kit according to the data stored in the order database, and confirming, according to the data stored in the stock database, whether reception of specific parts to be packaged in the parts kit has been completed by a predetermined number of days before the date of shipment; and

a collection instructing section (e.g., a collection instructing section 17 in the embodiment) for outputting a collection instruction sheet according to the data stored in the order database when completion of the reception of the specific parts to be packaged together is confirmed, wherein the collection instruction sheet includes data of the parts to be packaged together and the shelf position identification data.

According to the parts kit production support system having the above-explained structure, data of the parts slip which is appended to each received unit of parts is read out by an operator, and the read out data and the specification of the parts are associated with each other and stored into the order database in which the specification of the parts kit required by the orderer is stored, thereby accepting receipt of the parts. Regarding the parts whose receipt has already been accepted, the reception slip issuing section issues a reception slip in which parts identification data for identifying the received parts are described. Accordingly, the operator inputs the parts identification data described in the reception slip and the shelf position identification data individually assigned to a shelf on which the relevant parts are actually stored, by using a terminal, and both pieces of data are associated with each other and stored into the stock database by the stock management section, thereby performing stock management. Therefore, the operator can easily perform management of storage shelves for irregularly-received parts.

The stock state confirming section confirms the date of shipment of the parts kit according to the data stored in the order database, and confirms, according to the data stored in the stock database, whether reception of specific parts to be packaged in the parts kit has been completed by a predetermined number of days before the date of shipment. When completion of the reception of the specific parts to be packaged together is confirmed, the collection instructing section outputs a collection instruction sheet according to the data stored in the order database, wherein the collection instruction sheet includes data of the parts to be packaged together and the shelf position identification data. Therefore, the operator can quickly and reliably collects the parts to be packaged together, from each shelf position instructed in the collection instruction sheet. Accordingly, in the production of parts kits, efficiencies of the management of the storage shelves for irregularly-received parts and the collection of the parts to be packaged together can be improved. In addition, insufficient reception of necessary parts or errors in the reception of the parts can be avoided. Accordingly, it is possible to improve reliability of the parts kits (which are produced using the collected parts) as products. In addition, various data are unitarily managed; thus, manual mistakes can be prevented. Furthermore, according to the dynamic management employing the parts identification data and the shelf position identification data, it is unnecessary to provide shelves, each fixedly assigned to a unit or kind of parts; thus, efficiencies for physical elements, such as the area of the storage, can be improved.

The parts kit production support system may further comprise an insufficient parts confirming section (e.g., an insufficient parts confirming section 18 in the embodiment) for outputting a list of insufficient parts together with data of one or more manufacturers of the insufficient parts when the reception of the specific parts to be packaged together has not been completed.

According to the above structure, the insufficient parts confirming section outputs a list of insufficient parts together with data of the manufacturers of the insufficient parts; thus, the operator can quickly urge each manufacturer of the insufficient parts and also can perform (i) management of the parts whose reception has been delayed, (ii) approach for promoting reception of the parts, and (iii) preparation for jobs after the delay parts are received, based on the list of the insufficient parts.

Therefore, in the production of parts kits, efficiency of the collection of the parts to be packaged together can be improved. In particular, management of the parts whose reception has been delayed can be cautiously and carefully performed; thus, insufficient reception of necessary parts or errors in the reception of the parts can be avoided. Accordingly, it is possible to improve reliability of the parts kits (which are produced using the collected parts) as products.

The parts kit production support system may further comprise:

a packaging specification database (e.g., a packaging specification database 20 in the embodiment) for storing, in advance, specification of packaging for the parts to be packaged together; and

a packaging instructing section (e.g., a packaging instructing section 19 in the embodiment) for outputting, according to the data stored in the packaging specification database, a packaging instruction sheet for instructing packaging of the parts described in the collection instruction sheet.

According to the above structure, the packaging instructing section outputs a packaging instruction sheet for instructing packaging of the parts described in the collection instruction sheet (output by the collection instructing section), according to the data stored in the packaging specification database; thus, the operator can quickly perform packaging of the parts to be packaged together and produce the parts kit.

In this case, the parts kit production support system may further comprise a contents specification output section (e.g., a contents specification output section 21 in the embodiment) for outputting, according to data for indicating and identifying the parts to be packaged together, a specification which includes contents specification of the parts to be packaged together and is attached to the parts kit, wherein the data for indicating and identifying the parts to be packaged together is described in the packaging instruction sheet and is input using a terminal (e.g., packaging operation terminals 5-1 to 5-p in the embodiment).

According to the above structure, the operator reads out and inputs the data for indicating and identifying the parts to be packaged together (the data described in the packaging instruction sheet output by the packaging instructing section) by using a terminal. Based on the read out data for identifying the parts to be packaged together, the contents specification output section automatically outputs a specification which includes contents specification of the parts to be packaged together and is attached to the parts kit; thus, the operator can accurately produce the parts kit to which the specification is attached.

In the parts kit production support system, at least one of the parts slip data, the parts identification data, and the shelf position identification data may be indicated by a barcode. In addition, the data for indicating and identifying the parts to be packaged together may also be indicated by a barcode.

In this case, the operation of inputting such data performed by the operator can be simplified.

Accordingly, delicate steps such as packaging or label attachment, which are necessary for producing the parts kits, can be accurately performed according to the data input using barcodes and to instructions output by the parts kit production support system in response to the input data. Accordingly, various kinds of parts kits can be produced with minimum man power, as products having high reliability.

The present invention also provides a parts kit production support program of making a computer execute an operation for supporting production of a parts kit in which predetermined parts are packaged together, said operation comprising:

a reception accepting step of associating parts slip data with order data and storing the associated data into an order database, wherein the order database stores, in advance, the order data which indicates data of the parts kit required by an orderer, and specification data which indicates data of parts included in the parts kit, and the parts slip data, input using a terminal, is data of a parts slip which is appended to each received unit of parts;

a reception slip issuing step of issuing, according to the data stored in the order database, a reception slip in which parts identification data for identifying the received parts are described;

a stock management step of associating the parts identification data, which is described in the reception slip and is input using a terminal, with shelf position identification data which is also input using a terminal and is individually assigned to a shelf on which the relevant parts are stored, and storing the associated data into a stock database for storing data of stocked parts;

a stock state confirming step of confirming a date of shipment of the parts kit according to the data stored in the order database, and confirming, according to the data stored in the stock database, whether reception of specific parts to be packaged in the parts kit has been completed by a predetermined number of days before the date of shipment; and

a collection instructing step of outputting a collection instruction sheet according to the data stored in the order database when completion of the reception of the specific parts to be packaged together is confirmed, wherein the collection instruction sheet includes data of the parts to be packaged together and the shelf position identification data.

Accordingly, effects similar to those as described above can also be obtained by using this program.

### BRIEF DESCRIPTION OF THE DRAWINGS

FIG. 1 is a block diagram showing the structure of an embodiment of the parts kit production support system according to the present invention.

FIG. 2 is a flowchart showing the operation of the parts kit production support system in the embodiment.

FIG. 3 is a diagram showing an example of the reception slip output by the parts kit production support system in the embodiment.

FIG. 4 is a diagram showing an example of the collection instruction sheet output by the parts kit production support system in the embodiment.

FIG. 5 is a diagram showing an example of the packaging instruction sheet output by the parts kit production support system in the embodiment.

### DETAILED DESCRIPTION OF THE INVENTION

Hereinafter, embodiments according to the present invention will be explained with reference to the drawings.

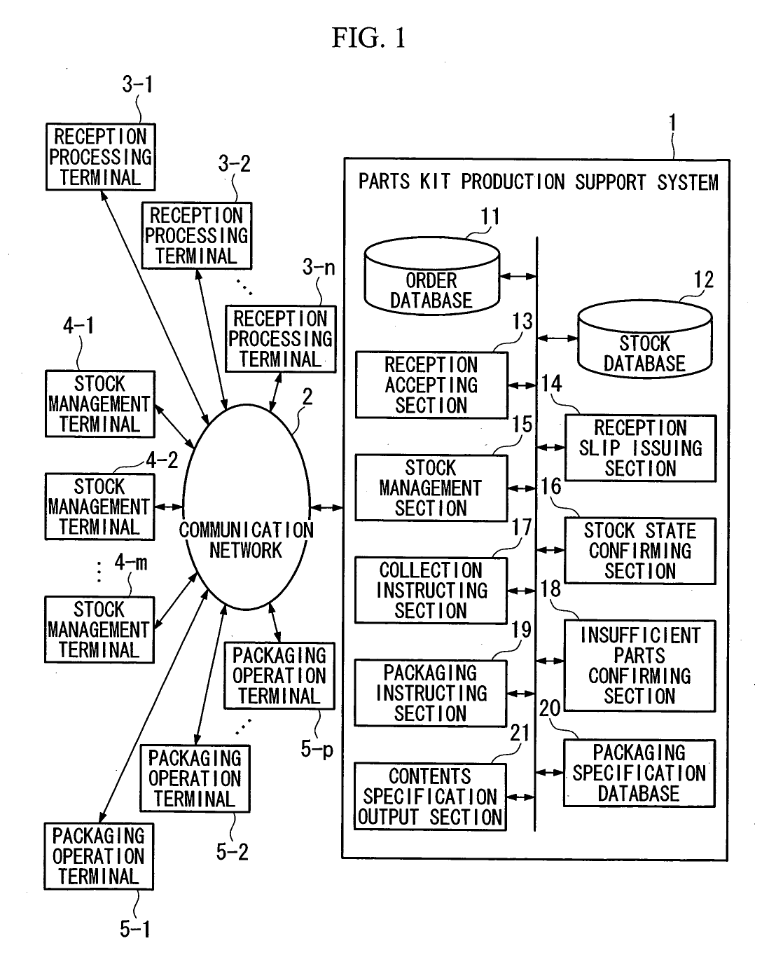

FIG. 1 is a block diagram showing the structure of the parts kit production system to which an embodiment of the parts kit production support system according to the present invention is applied.

In FIG. 1, reference numeral 1 indicates the parts kit production support system of the present embodiment, which is connected to reception processing terminals 3-1 to 3-n (n being an integer of 1 or greater), stock management terminals 4-1 to 4-m (m being an integer of 1 or greater), and packaging operation terminals 5-1 to 5-p (p being an integer of 1 or greater) via a communication network 2. The parts kit production support system uses data input from and output to the reception processing terminals 3-1 to 3-n, the stock management terminals 4-1 to 4-m, and the packaging operation terminals 5-1 to 5-p, so as to manage data relating to production of parts kits and to output data for supporting the production process of the parts kits.

The communication network 2 is a wire or wireless communication network for performing communication between (i) the parts kit production support system 1 and the reception processing terminals 3-1 to 3-n, (ii) the parts kit production support system 1 and the stock management terminals 4-1 to 4-m, and (iii) the parts kit production support system 1 and the packaging operation terminals 5-1 to 5-p.

That is, the reception processing terminals 3-1 to 3-n, the stock management terminals 4-1 to 4-m, and the packaging operation terminals 5-1 to 5-p should be connected via the communication network 2; however, the physical locations of these terminals are not limited.

As shown in FIG. 1, the parts kit production support system 1 has an order database 11, a stock database 12, a reception accepting section 13, a reception slip issuing section 14, a stock management section 15, a stock state confirming section 16, a collection instructing section 17, an insufficient parts confirming section 18, a packaging instructing section 19, a packaging specification database 20, and a contents specification output section 21.

The order database 11 is a database for storing in advance the order data (required by the orderer who issues an order) which include the appointed delivery date (or date of shipment) and the kind of each parts kit, and the specification of the parts kit (i.e., data of the parts included in the parts kit), and also for storing data of a parts slip attached to (each unit or set of) received parts which are accepted by the reception accepting section 13 (explained below).

The stock database 12 is a database for storing data of stocked parts. In this database, (i) parts identification data for identifying parts and (ii) shelf position identification data assigned to the shelf on which the relevant parts are actually stored, are stored, where both data are associated with each other.

The reception accepting section 13 is a processing section for storing the data of the parts slip attached to (each unit of) received parts into the order database 11, where the parts slip, input by an operator using a terminal, is associated with the order data which indicates the specification of the parts which is required by the orderer.

The reception slip issuing section 14 is a processing section for outputting a reception slip according to the data stored in the order database 11. In the reception slip, the parts identification data for identifying received parts is included.

The stock management section 15 is a processing section for storing (i) the parts identification data included in the reception slip which is input by an operator using a terminal and output from the reception slip issuing section 14 and (ii) the shelf position identification data individually assigned to each storage shelf on which the relevant parts are actually stored, into the stock database 12, where both pieces of stored data are associated with each other.

The stock state confirming section 16 is a processing section for confirming the date of shipment (or forwarding) of each parts kit in which specific (or specified) parts are packaged, according to the data stored in the order database 11, and also confirming whether receipt of specific parts to be packaged together has been completed by a predetermined number of days before the date of shipment, according to the data stored in the stock database 12.

The collection instructing section 17 is a processing section for outputting a collection instruction sheet based on the data stored in the order database 11 when the completion of reception of the specific parts to be packaged together is confirmed by the stock state confirming section 16. In the collection instruction sheet, data of the parts to be packaged together and the shelf position identification data are described.

The insufficient parts confirming section 18 is a processing section for outputting a list of insufficient parts when the stock state confirming section 16 confirms that the reception of the specific parts to be packaged together has not yet been completed. Here, data for the manufacturer of the insufficient parts are also output together with the list of the insufficient parts.

The packaging instructing section 19 is a processing section for outputting a packaging instruction sheet for the parts indicated in the collection instruction sheet which is output by the collection instructing section 17, according to the data stored in the packaging specification database 20 in which specification of packaging of the parts is stored in advance.

The contents specification output section 21 is a processing section for outputting a specification which includes contents specification (attached to each parts kit) of the relevant parts to be packed together, according to data for identifying the parts included in the parts kit, where the data is provided in the packaging instruction sheet output by the packaging instructing section 19.

The order database 11, the stock database 12, and the packaging specification database 20 are realized by a computer-readable and writable storage medium which may be a nonvolatile memory such as a flash memory or a volatile memory such as a RAM (random access memory), or a combination of nonvolatile and volatile memories.

Each of the reception accepting section 13, the reception slip issuing section 14, the stock management section 15, the stock state confirming section 16, the collection instructing section 17, the insufficient parts confirming section 18, the packaging instructing section 19, and the contents specification output section 21 may be realized by a hardware resource for exclusive use, or may be realized by a memory and a CPU (central processing unit) in which a program for executing the function of each section is loaded on the memory so as to execute the function.

The parts kit production support system 1 also has an input device, a display device, an output device (none of which is shown), and the like. The input device may be a keyboard or a mouse. The display device may be a CRT (cathode ray tube) display or an LCD (liquid crystal display) or a speech generating device such as a speaker. The output device may be a printing device (or a printer) for outputting various data (which are output by the parts kit production support system 1 so as to support the process for producing parts kits) as a slip. The output device should be connected via the communication network 2; however, the physical location of this device is not limited.

Below, the operations of the present embodiment will be explained with reference to the drawings.

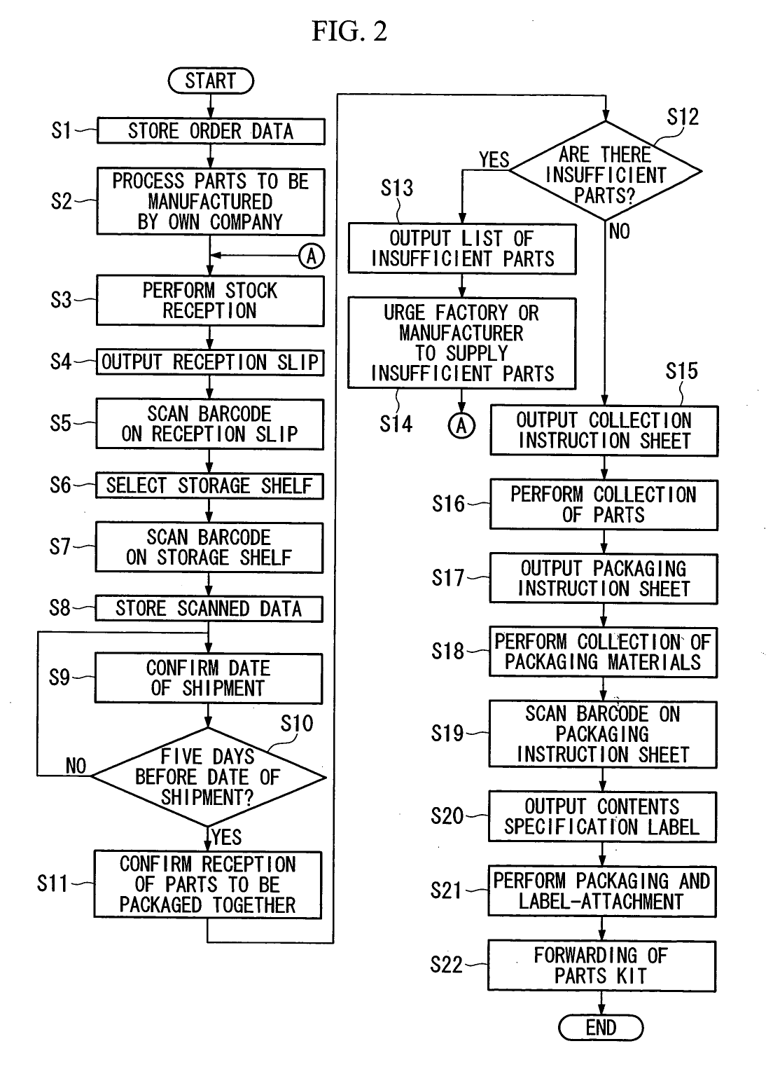

FIG. 2 is a flowchart showing the process of producing parts kits by using the parts kit production support system of the present embodiment. The following explanation employs an example of producing parts kits for industrial products such as motorcars (i.e., four-wheeled vehicles) or two-wheeled vehicles.

In FIG. 2, the parts kit manufacturer associates the order data, which indicates data for the parts kit required and ordered by the orderer, with the specification data including data of parts to be packaged in the parts kit, and stores both data into the order database 11 (see step S1). Here, the parts to be packaged together as the parts kit include parts manufactured by the parts kit manufacturer itself and supplied parts manufactured by a dedicated supplied parts manufacturer.

Therefore, when some kind of required parts should be produced by the parts kit manufacturer itself, the parts kit manufacturer performs the production of the parts (see step S2). Regarding the parts produced by the dedicated supplied parts manufacturer, an order is separately issued from a person in charge (i.e., orderer) to the supplied parts manufacturer, by which the parts kit manufacturer receives the relevant parts from the supplied parts manufacturer.

When the parts produced by the parts kit manufacturer itself or the parts produced by the supplied parts manufacturer are stocked, the parts kit manufacturer performs stock reception in the storage by using the reception processing terminals 3-1 to 3-n. Specifically, the barcode attached to each received unit of parts is scanned using a barcode scanner provided at the reception processing terminals 3-1 to 3-n, so that the parts slip data, input by the operator by using the reception processing terminals 3-1 to 3-n, is stored, in association with the order data, into the order database 11 by the reception accepting section 13 of the parts kit production support system 1.

Based on the data stored in the order database 11, the reception slip issuing section 14 of the parts kit production support system 1 outputs the reception slip, which includes the parts identification data for identifying the received parts (i.e., the reception number used by the parts kit manufacturer), via the output device (see step S4).

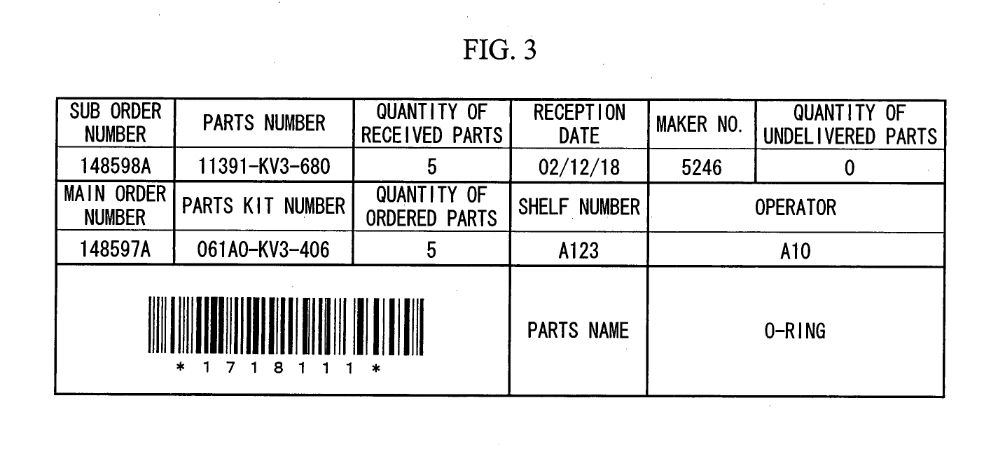

As shown in FIG. 3, the reception slip includes data of (i) sub order number which is the order number submitted from the orderer to the supplied parts manufacturer, (ii) parts number which is the number of (a kind of) parts included in a parts kit, (iii) quantity of received parts, (iv) reception date, (v) maker No. which is the code number of the supplied parts manufacturer, (vi) quantity of undelivered parts (i.e., which have not yet been received), (vii) main order number which is the order number submitted from the orderer to the parts kit manufacturer, (viii) parts kit number assigned to the parts kit, (ix) parts identification data (i.e., reception number, more specifically, the barcode which indicates the reception number used by the parts kit manufacturer), etc.

When the reception slip is output, the parts kit manufacturer stores the relevant parts into the storage, by using the stock management terminals 4-1 to 4-m. Specifically, the operator scans the barcode printed on the reception slip by using a barcode scanner provided at the stock management terminals 4-1 to 4-m (see step S5). The operator then selects a parts storage shelf (see step S6) and scans the barcode individually assigned to the parts storage shelf by using the barcode scanner provided at the stock management terminals 4-1 to 4-m (see step S7). Accordingly, the stock management section 15 of the parts kit production support system 1 associates (i) parts identification data input by the operator by using the stock management terminals 4-1 to 4-m, and (ii) shelf position identification data (i.e., the number indicating the location of the relevant shelf) which is also input by the operator by using the stock management terminals 4-1 to 4-m, with each other, and stores the associated data into the stock database 12 (see step S8).

Next, based on the data stored in the order database 11, the stock state confirming section 16 of the parts kit production support system 1 confirms the date of shipment of the ordered parts kit (see step S9), and determines whether today is, for example, five days before the date of shipment of the parts kit (see step S110) so as to extract a parts kit whose date of shipment is drawing near.

If it is determined in step S110 that today is not five days before the date of shipment of the relevant parts kit (i.e., “NO” in step S10), the operation returns to step S9, and the operation from step S9 to step S110 is repeated.

If it is determined in step S110 that today is five days before the date of shipment of the relevant parts kit (i.e., “YES” in step S110), the stock state confirming section 16 confirms, based on the data stored in the stock database 12, whether specific parts to be packaged together in the relevant parts kit have been received by a predetermined number of days before the date of shipment (see step S11) and determines whether there are insufficient parts (see step S12).

If it is determined in step S12 that there are insufficient parts to be packaged together (i.e., “YES” in step S12), the insufficient parts confirming section 18 of the parts kit production support system 1 outputs a list of the insufficient parts together with data of (one or more) manufacturers of the insufficient parts, via the output device (see step S13).

According to the list, the parts kit manufacturer urges the factory (of its own) to supply the insufficient parts if the parts should be produced by its own company, or urges the relevant supplied parts manufacturer to supply the insufficient parts if the parts should be produced by the supplied parts manufacturer (see step S14). The operation then returns to step S3, and the operation from step S3 is repeated.

If it is determined in step S12 that there are no insufficient parts to be packaged together (i.e., “NO” in step S10), the collection instructing section 17 of the parts kit production support system 1 outputs, based on the data stored in the order database 11, the collection instruction sheet which provides the data of the parts to be packaged together and the shelf position identification data, via the output device (see step S15).

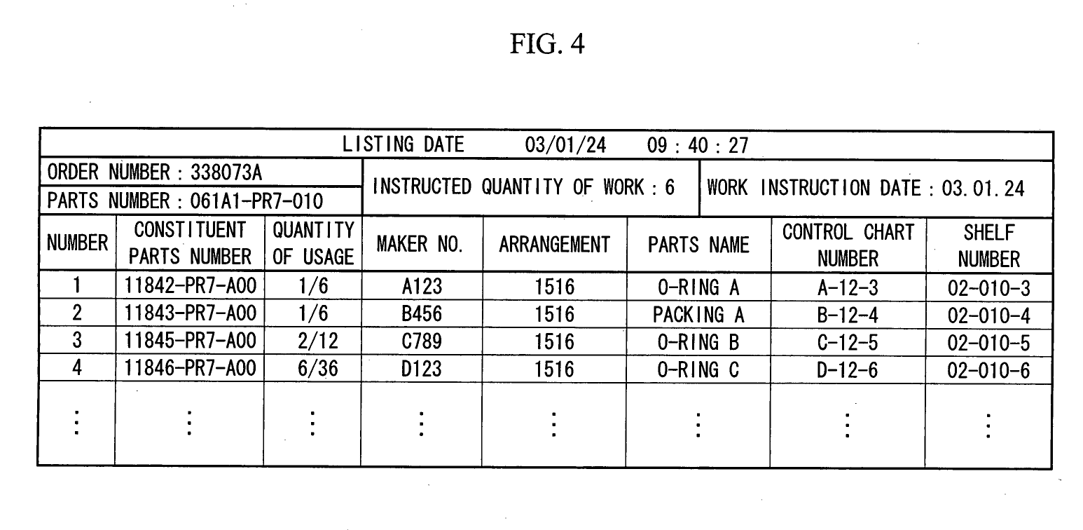

As shown in FIG. 4, the collection instruction sheet includes (i) order number, (ii) parts number (in this sheet, the number of the parts kit), (iii) instructed quantity of work (i.e., quantity of ordered parts), (iv) constituent parts number (i.e., number of parts to be packaged together), (v) quantity of usage, that is, quantity of necessary parts (“x/y” means “(quantity per kit)/(entire quantity)”), (vi) maker No., (vii) parts name, (viii) control chart number which is the chart number used by the parts kit manufacturer, (ix) shelf number (i.e., shelf position identification data), etc.

The operator performs collection of the parts, according to the collection instruction sheet (see step S16).

On the other hand, based on the data stored in the packaging specification database 20 (in which specification of packaging of the parts are stored in advance), the packaging instructing section 19 of the parts kit production support system 1 outputs a packaging instruction sheet for the parts indicated in the collection instruction sheet, via the output device (see step S17).

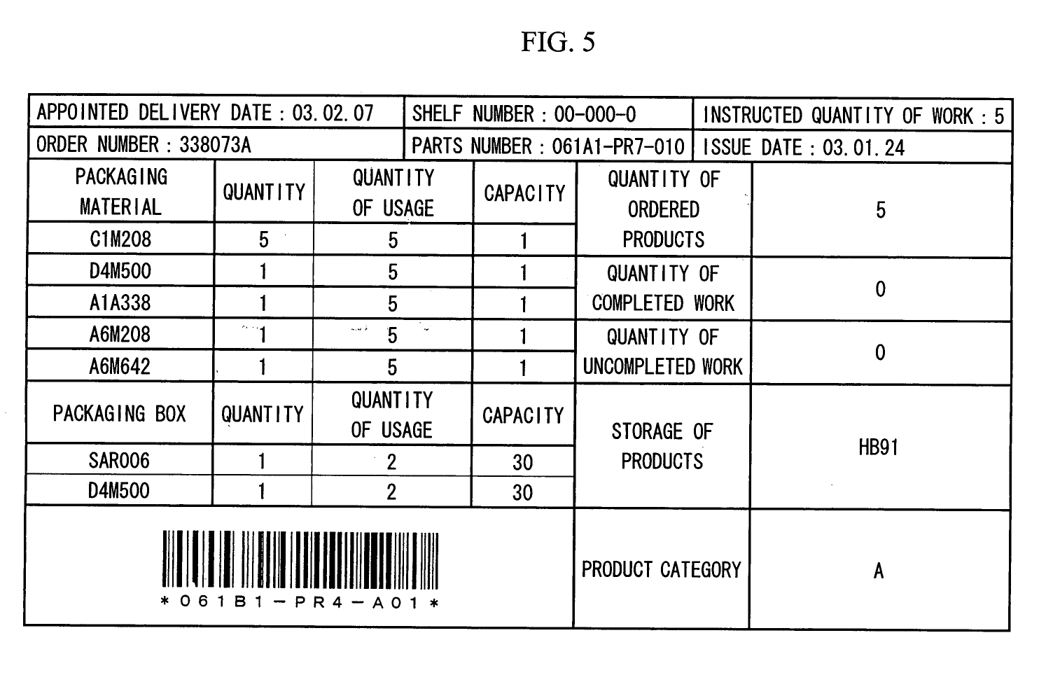

As shown in FIG. 5, the packaging instruction sheet includes (i) appointed delivery date, (ii) instructed quantity of work, (iii) order number, (iv) parts number, (v) packaging material for item (or separate) packaging, (vi) quantity of item packaging, (vii) quantity of usage of item packaging, (viii) packaging box (material) for outer packaging, (ix) quantity of outer packaging, (x) capacity of the packaging material or the box, (xi) issue date, (xii) storage of products (i.e., into which the products are carried), (xiii) data for identifying the parts to be packaged together (i.e., barcode indicating the parts number of the parts kit), (xiv) product category (“A” indicates the parts kit includes supplied parts, and “1” indicates the parts kit includes only parts manufactured by its own company), etc.

The operator performs collection of the packaging materials, according to the packaging instruction sheet (see step S18).

When the collection of packaging material performed by the operator is completed, the barcode printed on the packaging instruction sheet is scanned using a barcode scanner provided at the packaging operation terminals 5-1 to 5-p (see step S19). Accordingly, based on the parts number of the parts kit (i.e., data used for identifying the parts included in the parts kit), input by the operator using the packaging operation terminals 5-1 to 5-p, the contents specification output section 21 of the parts kit production support system 1 outputs a specification to be appended to the relevant parts kit, that is, a so-called “contents specification label” which includes the contents specification of the parts included in the parts kit, via the output device (see step S20).

Accordingly, the operator performs packaging based on the packaging instruction sheet and attaches the output contents specification label to the parts kit, thereby completing the parts kit (see step S21).

Each finished parts kit is forwarded based on the appointed delivery date stored in the database 11 (see step S22).

There is no necessity for collecting all structural elements of the parts kit production support system 1 in a single apparatus, and these structural elements may be provided in separate apparatuses which are connected to the communication network 2.

The functions of the parts kit production support system 1 may be performed by storing a program for executing the functions in a computer readable storage medium, and making a computer system load and execute the program.

The computer system includes hardware resources such as an OS and peripheral devices. If the computer system employs a WWW (world wide web) system, the computer system can provide a homepage viewable environment. The above computer readable storage medium is, for example, a portable medium such as a diskette, magneto optical disk, ROM, or CD-ROM, or a memory device such as a hard disk built in a computer system. The computer readable storage medium also includes a memory for temporarily storing the program, such as a RAM which is a volatile storage medium in a computer system which functions as a server or client and receives the program via a network (e.g., the Internet) or a communication line (e.g., a telephone line).

The above program, stored in a memory device of a computer system, may be transmitted via a transmission medium, or by using transmitted waves passing through a transmission medium, to another computer system. The transmission medium for transmitting the program has a function of transmitting data, and is, for example, a (communication) network such as the Internet or a communication line such as a telephone line. In addition, the program may be for executing a part of the above-explained functions, or these functions may be executed by a combination program of a “differential” program stored in a computer readable storage medium and an existing program which has already been stored in the computer system.

As explained above, in the parts kit production support system 1 of the present embodiment, the stock management section 15 performs stock management based on (i) the parts identification data described in the reception slip issued by the reception slip issuing section 14 and (ii) the shelf position identification data individually assigned to a shelf which actually stores the parts. In addition, the collection instruction sheet, in which data of the parts to be packaged together and the shelf position identification data are described, is output by the collection instructing section 17. Therefore, the operator can quickly and reliably collect the parts to be packaged together from each shelf position indicated by the collection instruction sheet.

Additionally, when the stock state confirming section 16 confirms that reception of specific parts which should be packaged together has not yet been completed, the insufficient parts confirming section 18 outputs a list of insufficient parts together with data relating to the manufacturers of the insufficient parts. Therefore, according to the data of the manufacturers of the insufficient parts included in the list, the operator can quickly urge each manufacturer of the insufficient parts and also can perform (i) management of the parts whose reception has been delayed, (ii) approach for promoting reception of the parts, and (iii) preparation for jobs after the delay parts are received.

Therefore, in the production of parts kits, efficiencies of the management of the storage shelves for irregularly-received parts and the collection of the parts to be packaged together can be improved. In particular, management of the parts whose reception has been delayed can be cautiously and carefully performed; thus, insufficient reception of necessary parts or errors in the reception of the parts can be avoided. Accordingly, it is possible to improve reliability of the parts kits (which are produced using the collected parts) as products. In addition, various data are unitarily managed; thus, manual mistakes can be prevented. Furthermore, according to the dynamic management employing the parts identification data and the shelf position identification data, it is unnecessary to provide shelves, each fixedly assigned to a unit or kind of parts; thus, efficiencies for physical elements, such as the area of the storage, can be improved.

In addition, according to the packaging instruction sheet output by the packaging instructing section 19, the operator can quickly perform packaging of the parts to be packaged together, produce each parts kit, and attach a specification (output by the contents specification output section 21, which includes the contents specification of the parts included in the parts kit) to the parts kit, thereby accurately producing each parts kit to which the specification is attached. Furthermore, the parts slip data, the parts identification data, the data for identifying the parts to be packaged together, and the shelf position identification data are each indicated by a barcode; thus, the input operation of each data by the operator can be simplified.

Therefore, delicate steps such as packaging or label attachment, which are necessary for producing the parts kits, can be accurately performed according to the data input using barcodes and to instructions output by the parts kit production support system in response to the input data. Accordingly, various kinds of parts kits can be produced with minimum man power, as products having high reliability.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A parts kit production support system for supporting production of a parts kit in which predetermined parts are packaged together, comprising:
an order database for storing, in advance, order data which indicates data of the parts kit required by an orderer, and specification data which indicates data of parts included in the parts kit;
a stock database for storing data of stocked parts;
a reception accepting section for associating parts slip data with the order data and storing the associated data into the order database, wherein the parts slip data, input using a terminal, is data of a parts slip which is appended to each received unit of parts;
a reception slip issuing section for issuing, according to the data stored in the order database, a reception slip in which parts identification data for identifying the received parts are described;
a stock management section for associating the parts identification data, which is described in the reception slip and is input using a terminal, with shelf position identification data which is also input using a terminal and is individually assigned to a shelf on which the relevant parts are stored, and storing the associated data into the stock database;
a stock state confirming section for confirming a date of shipment of the parts kit according to the data stored in the order database, and confirming, according to the data stored in the stock database, whether reception of specific parts to be packaged in the parts kit has been completed by a predetermined number of days before the date of shipment; and
a collection instructing section for outputting a collection instruction sheet according to the data stored in the order database when completion of the reception of the specific parts to be packaged together is confirmed, wherein the collection instruction sheet includes data of the parts to be packaged together and the shelf position identification data.

2. A parts kit production support system as claimed in claim 1, further comprising:
an insufficient parts confirming section for outputting a list of insufficient parts together with data of one or more manufacturers of the insufficient parts when the reception of the specific parts to be packaged together has not been completed.

3. A parts kit production support system as claimed in claim 1, further comprising:
a packaging specification database for storing, in advance, specification of packaging for the parts to be packaged together; and
a packaging instructing section for outputting, according to the data stored in the packaging specification database, a packaging instruction sheet for instructing packaging of the parts described in the collection instruction sheet.

4. A parts kit production support system as claimed in claim 3, further comprising:
a contents specification output section for outputting, according to data for indicating and identifying the parts to be packaged together, a specification which includes contents specification of the parts to be packaged together and is attached to the parts kit, wherein the data for indicating and identifying the parts to be packaged together is described in the packaging instruction sheet and is input using a terminal.

5. A parts kit production support system as claimed in claim 1, wherein at least one of the parts slip data, the parts identification data, and the shelf position identification data is indicated by a barcode.

6. A parts kit production support system as claimed in claim 4, wherein the data for indicating and identifying the parts to be packaged together is indicated by a barcode.

7. A parts kit production support program of making a computer execute an operation for supporting production of a parts kit in which predetermined parts are packaged together, said operation comprising:
a reception accepting step of associating parts slip data with order data and storing the associated data into an order database, wherein the order database stores, in advance, the order data which indicates data of the parts kit required by an orderer, and specification data which indicates data of parts included in the parts kit, and the parts slip data, input using a terminal, is data of a parts slip which is appended to each received unit of parts;
a reception slip issuing step of issuing, according to the data stored in the order database, a reception slip in which parts identification data for identifying the received parts are described;
a stock management step of associating the parts identification data, which is described in the reception slip and is input using a terminal, with shelf position identification data which is also input using a terminal and is individually assigned to a shelf on which the relevant parts are stored, and storing the associated data into a stock database for storing data of stocked parts;
a stock state confirming step of confirming a date of shipment of the parts kit according to the data stored in the order database, and confirming, according to the data stored in the stock database, whether reception of specific parts to be packaged in the parts kit has been completed by a predetermined number of days before the date of shipment; and
a collection instructing step of outputting a collection instruction sheet according to the data stored in the order database when completion of the reception of the specific parts to be packaged together is confirmed, wherein the collection instruction sheet includes data of the parts to be packaged together and the shelf position identification data.
